(19) United States
(12) Patent Application Publication
(10) Pub. No.: US 2009/0160648 A1
(43) Pub. Date: Jun. 25, 2009

(54) Method and apparatus for bulk calibrating RFID tags

(75) Inventor: Shahriar Rokhsaz, Austin, TX (US)

Correspondence Address: J. V. Myers & Associates, PC, P.O. Box 130, Driftwood, TX, 78619, US

(73) Assignee: RFMicron, Inc.

(21) Appl. No.: 12/004,606

(22) Filed: Dec. 24, 2007

(51) Int. Cl. G08B 13/14

(52) U.S. Cl. 340/572.1

(57) ABSTRACT

A method and apparatus for bulk calibrating self-tuning radio frequency identification (“RFID”) tags wherein a plurality of the tags are simultaneously exposed to a broadcast RF signal of sufficient strength and for a sufficient period of time to assure self-calibration of all tags.

### BACKGROUND OF THE INVENTION

1. Field of the Invention

The present invention relates generally to radio frequency identification tags, and, in particular, to a method and apparatus for bulk calibrating radio frequency identification tags.

2. Description of the Related Art

In general, in the descriptions that follow, I will italicize the first occurrence of each special term of art which should be familiar to those skilled in the art of radio frequency (“RF”) communication systems. In addition, when I first introduce a term that I believe to be new or that I will use in a context that I believe to be new, I will bold the term and provide the definition that I intend to apply to that term. In addition, throughout this description, I will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, I may refer to the mutually exclusive boolean states as logic_{—}0 and logic_{—}1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

In general, in an RF communication system, an antenna structure is used to receive signals, the carrier frequencies (“f_{C}”) of which may vary significantly from the natural resonant frequency (“f_{R}”) of the antenna. It is well known that mismatch between f_{C} and f_{R} results in loss of transmitted power. In some applications, this may not be of particular concern, but, in others, such as in RF identification (“RFID”) applications, such losses are of critical concern. For example, in a passive RFID tag, a significant portion of received power is used to develop all of the operating power required by the tag's electrical circuits. In such an application, it is known to employ a variable impedance circuit to shift the f_{R} of the tag's receiver so as to better match the f_{C} of the transmitter of the system's RFID reader.

Although it would be highly desirable to have a single design that is useful in all systems, one very significant issue in this regard is the diversity of international standards as to appropriate RFID system frequencies, and, to the extent there is any de facto standardization, the available frequency spectrum is quite broad: Low-Frequency (“LF”), including 125-134.2 kHz and 140-148 kHz; High-Frequency (“HF”) at 13.56 MHz; and Ultra-High-Frequency (“UHF”) at 860-960 MHz. Compounding this problem is the fact that system manufacturers cannot agree on which specific f_{C} is the best for specific uses, and, indeed, to prevent cross-talk, it is desirable to allow each system to distinguish itself from nearby systems by selecting different f_{C} within a defined range.

As explained in, for example, U.S. Pat. No. 7,055,754 (incorporated herein by reference), attempts have been made to improve the ability of the tag's antenna to compensate for system variables, such as the materials used to manufacture the tag. However, such structural improvements, while valuable, do not solve the basic need for a variable impedance circuit having a relatively broad tuning range.

Shown in FIG. 1 is an ideal variable impedance circuit 2 comprised of a variable inductor 4 and a variable capacitor 6 coupled in parallel with respect to nodes 8 and 10. In such a system, the undamped resonance or resonant frequency of circuit 2 is:

$${ω}_{R} = \frac{1}{\sqrt{LC}} \qquad [ Eq . 1 ]$$

where:
ω_{R}=the resonant frequency in radians per second;
L=the inductance of inductor 2, measured in henries; and
C=the capacitance of capacitor 6, measured in farads.

On, in the alternative form:

$${f}_{R} = \frac{{ω}_{R}}{2 π} = \frac{1}{2 π \sqrt{LC}} \qquad [ Eq . 2 ]$$

where: f_{R}=the resonant frequency in hertz.

As is well known, the total impedance of circuit 2 is:

$$Z = \frac{RLS}{{RLCS}^{2} + LS + R} \qquad [ Eq . 3 ]$$

where:
Z=the total impedance of circuit 2, measured in ohms;
R=the total resistance of circuit 2, including any parasitic resistance(s), measured in ohms;
L=the inductance of inductor 2, measured in henries; and
S=jω;
where:
   j=the imaginary unit \sqrt{−1}; and
   ω is the resonant frequency in radians-per-second.

As is known, for each of the elements of circuit 2, the relationship between impedance, resistance and reactance is:

Zₑ=Rₑ+jXₑ [Eq. 4]

where:
Zₑ=impedance of the element, measured in ohms;
Rₑ=resistance of the element, measured in ohms;
j=the imaginary unit \sqrt{−1}; and
Xₑ=reactance of the element, measured in ohms.

Although in some situations phase shift may be relevant, in general, it is sufficient to consider just the magnitude of the impedance:

|Zₑ|=\sqrt{Rₑ²+Xₑ²} [Eq. 5]

For a purely inductive or capacitive element, the magnitude of the impedance simplifies to just the respective reactances. Thus, for inductor 4, the magnitude of the reactance can be expressed as:

X_{L}=|j2πfL|=2πfL [Eq. 6]

Similarly, for capacitor 6, the magnitude of the reactance can be expressed as:

$${X}_{C} = \vert \frac{1}{j2π fC} \vert = \frac{1}{2 π fC} \qquad [ Eq . 7 ]$$

Because the reactance of inductor 4 is in phase while the reactance of capacitor 6 is in quadrature, the reactance of inductor 4 is positive while the reactance of capacitor 6 is negative. Resonance occurs when the absolute values of the reactances of inductor 4 and capacitor 6 are equal, at which point the reactive impedance of circuit 2 becomes zero, leaving only a resistive load.

As is known, the response of circuit 2 to a received signal can be expressed as a transfer function of the form:

$$H ( j ω ) = \frac{\frac{1}{R} + j ( - C ω + \frac{1}{L ω} )}{\frac{1}{{R}^{2}} + {( - C ω + \frac{1}{L ω} )}^{2}} \qquad [ Eq . 8 ]$$

Within known limits, changes can be made in the relative values of inductor 4 and capacitor 6 to converge the resonant frequency, f_{R}, of circuit 2 to the carrier frequency, f_{C}, of a received signal. As a result of each such change, the amplitude response of circuit 2 will get stronger. In contrast, each change that results in divergence will weaken the amplitude response of circuit 2.

As shown in the variable tank circuit 2′ in FIG. 2, in many applications, such as RFID tags, it may be economically desirable to substitute for variable inductor 4 a fixed inductor 4′. In addition, one must take into consideration the inherent input resistance, R_{I}, of the load circuit 12, as well as the parasitic resistances 14a of inductor 4′ and 14b of capacitor 6.

A discussion of these and related issues can be found in the Masters Thesis of T. A. Scharfeld, entitled “An Analysis of the Fundamental Constraints on Low Cost Passive Radio-Frequency Identification System Design”, Massachusetts Institute of Technology (August 2001), a copy of which is submitted herewith and incorporated herein in its entirety by reference.

A method and apparatus for automatically accomplishing such convergence in the receiver circuit of an RFID tag is described in my copending application, “Method and Apparatus for Varying an Impedance,” application Ser. No. 11/601,085, filed 18 Nov. 2006, which is hereby incorporated herein in its entirety by reference. However, other methods and apparatus are known for automatically tuning the tank circuits in passive RFID tags. For convenience of reference, I shall hereafter refer to such tags as self-tuning tags.

While such methods and apparatus are fully effective to accomplish convergence of self-tuning tags in a field environment, their efficiency is generally dependent on the field strength of the received RF signal. If, due to normal manufacturing variations, the initial resonant frequency of the tag is offset significantly from the carrier frequency of the received signal, the tag may be unable to converge unless and until either: (a) the field strength of the received signal is increased above normal operating level; or (b) the tag is brought into unusually close proximity to the transmitter. In either case, the user of the tag is required to take special steps to assure operability of the tag.

I submit that what is needed is an efficient method and apparatus for bulk calibrating self-tuning RFID tags, and, in particular, wherein, during manufacturing, a plurality of self-tuning RFID tags are submitted to calibration simultaneously under conditions selected to assure convergence of all tags.

### BRIEF SUMMARY OF THE INVENTION

In accordance with a preferred embodiment of my invention, I provide a method for simultaneously calibrating at least a first and a second radio frequency (“RF”) identification tag, each tag being adapted to self-tune when exposed for at least a first period of time to an RF signal of a predetermined frequency and at least a first predetermined strength. In a preferred form, I broadcast an RF signal of the predetermined frequency and a second predetermined strength which is greater than the first predetermined strength. I then simultaneously expose at least first and second tags to the broadcast signal such that the strength of the signal received by each of the tags is at least the first predetermined strength. Finally, I continue such exposure for a second period of time which is at least as long as the first period of time.

In accordance with another preferred embodiment of my invention, I provide an apparatus for simultaneously calibrating at least a first and a second radio frequency (“RF”) identification tag, each tag being adapted to self-tune when exposed for at least a first period of time to an RF signal of a predetermined frequency and at least a first predetermined strength. In a preferred form, the apparatus includes an RF transmitter adapted to produce an RF signal of the predetermined frequency and a second predetermined strength which is greater than the first predetermined strength. An antenna is coupled to the transmitter and adapted to broadcast the RF signal. I provide a structure adapted to support at least first and second tags in proximity to the antenna so as to simultaneously expose the first and second tags to the broadcast signal such that the strength of the signal received by each of the tags is at least the first predetermined strength. Finally, I include a timer adapted to continue the exposure for a second period of time which is at least as long as the first period of time.

I submit that each of these embodiments of my invention more efficiently calibrate self-tuning RFID tags than any prior art method or apparatus now known to me.

### BRIEF DESCRIPTION OF THE SEVERAL VIEWS OF THE DRAWINGS

My invention may be more fully understood by a description of certain preferred embodiments in conjunction with the attached drawings in which:

FIG. 1 is an ideal variable impedance tank circuit;

FIG. 2 is a practical embodiment of the tank circuit shown in FIG. 1;

FIG. 3 illustrates in block diagram form a system for bulk calibrating a plurality of self-tuning RFID tags, constructed in accordance with the preferred embodiment of my invention; and

FIG. 4 illustrates in flow diagram form the operation of the system of FIG. 3.

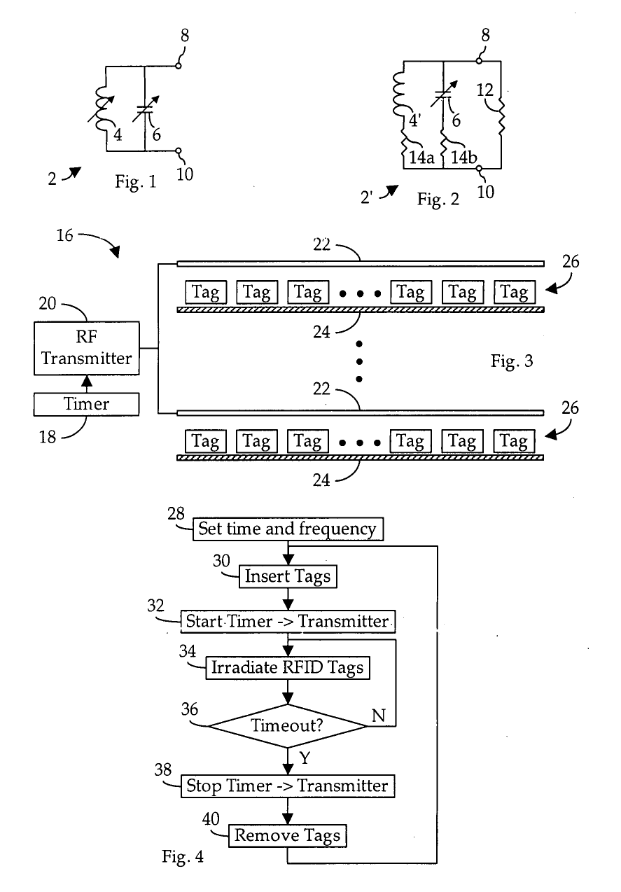

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

Shown in FIG. 3 is a bulk calibration system 16 constructed in accordance with the preferred embodiment of my invention. In the calibration system 16, a timer 18 selectively enables an RF transmitter 20 to broadcast, via an antenna 22, an RF signal, the carrier frequency of which is selected within one of the established RFID system operating frequency ranges, as discussed above. For example, within the low-frequency (“LF”) range of 125-134.2 kHz, a frequency of around 125 kHz would be appropriate; whereas, for the high-frequency (“HF”) range, 13.56 MHz would be appropriate; and, for the ultra-high-frequency (“UHF”) 910 MHz would be appropriate. Of course, other frequencies may be appropriate for specific applications or for tags intended for use in countries having specified standards for such tags.

A structure 24, such as a tag carrier tray or the like, is provided to support a plurality of conventional self-tuning RFID tags 26. In general, each of the tags 26 is designed so as to be able to self-tune upon being exposed for a predetermined period of time to an RF signal of predetermined frequency and field strength. Depending on the design, the length of exposure and the requisite RF frequency and field strength will vary. Due to normal manufacturing variables, the initial resonant frequency of each tag will, in general, be different. Furthermore, such manufacturing variables will result in differences in both the field strength and in the time required for each tag to self-tune. Using conventional engineering design techniques, each manufacturer will determine the worst-case requirements for each of their products.

Taking into account such requirements, it is possible to determine how closely the structure 24 must be positioned to the antenna 22 so as to assure that each of the tags 26 is exposed to at least the minimum amount of RF energy required for that tag to self-tune. Then, by setting timer 18 such that all of the tags 26 are exposed for at least the anticipated worst-case self-tuning time, self-tuning of all of the tags 26 is assured. In effect, this bulk calibration of the tags 26 makes it more likely that, when first used in the field, each tag will already be sufficiently closely tuned to the local system frequency so as to operate properly without special handling.

Preferably, antenna 22 and structure 24 are both contained within an enclosure (not shown) designed to maximize the efficiency of energy transfer from antenna 22 to the tags 26, while facilitating easy insertion and removal of batches of the tags 26. To minimize overall power consumption, antenna 22 and structure 24 should be disposed as close to each other as possible while providing sufficient clearance to assure that tags 26 are not damaged during insertion and removal. As shown by way of illustration in FIG. 3, calibration system 16 may be configured as multiple calibration units or chambers, each capable of simultaneously calibrating a subset of the entire batch of tags 26. In this way, a single control system is able simultaneously to operate a number of relatively-high-efficiency calibration units or chambers.

In general, the calibration system 16 operates as shown in FIG. 4. Depending on the specific type of tags 26 to be calibrated, the manufacturer-specified, minimum calibration time period is used to set timer 18 and the application-specific RF carrier frequency is used to set transmitter 20 (step 28). A batch of tags 26 can then be arranged on structure 24 so as to be exposed to RF energy radiated by antenna 22 (step 30). Upon activating timer 18 (step 32), transmitter 20 initiates broadcast, via antenna 22, of an RF signal having the selected carrier frequency, thereby irradiating tags 26 with the broadcast RF energy (step 34) for the selected time set on timer 18 (step 36). Upon timeout of timer 18 (step 38), transmitter 20 ceases operation, allowing the calibrated tags 26 to be removed (step 40).

Preferably, during initial operation of the calibration system 16, a statistically significant number of the tags 26 are tested, following calibration, to verify that the system is operating correctly. As required, either the time duration or signal strength can be adjusted to assure proper operation. Thereafter, periodically, samples should be tested to verify continued proper operation.

In an alternate form, the structure 24 can comprise a moving surface, such as a conveyor belt, which continuously conveys the tags 26 past the antenna 22. The speed of the motion of the tags 26 should be such that each is exposed to the broadcast RF energy for a sufficient period of time to assure self-calibration. Of course, this arrangement can be easily adapted continuously to move batches of tags 26, and, if desired, to operate in a generally periodic manner, moving each batch into the calibration chamber once the previous batch has been calibrated. Depending on production requirements, the speed and periodicity of motion and the signal strength can be varied, with speed being related to signal strength. If desired, a tag tester, such as I have described above, can be integrated into the calibration system 16 to form a statistical control feedback system so as automatically to vary the settings of timer 18 and transmitter 20, depending on the results of the testing.

In both the batch and continuous calibration systems, the enclosure will require careful design so that a minimal amount of RF energy is wasted. Such losses are also of concern due to possible interference with other, unrelated RF systems.

Thus it is apparent that I have provided an efficient method and apparatus for bulk calibrating self-tuning RFID tags. Those skilled in the art will recognize that modifications and variations can be made without departing from the spirit of my invention. For example, although in the embodiments I have described I have focused on the calibration of the tank circuit 2′, the same process I have shown in FIG. 4 would be equally suitable to calibrate the on-tag, free-running oscillator (not shown) that is used to generate the on-tag dock signals. Therefore, I intend that my invention encompass all such variations and modifications as fall within the scope of the appended claims.

What I claim is:

1. A method for simultaneously calibrating at least a first and a second radio frequency (“RF”) identification tag, each tag being adapted to self-tune when exposed for at least a first period of time to an RF signal of a predetermined frequency and at least a first predetermined strength, the method comprising the steps of:
broadcasting an RF signal of said predetermined frequency and a second predetermined strength which is greater than said first predetermined strength;
simultaneously exposing said first and second tags to said broadcast signal such that the strength of said signal received by each of said tags is at least said first predetermined strength; and
continuing such exposure for a second period of time which is at least said first period of time.

2. The method of claim 1 wherein the predetermined frequency is a low-frequency (“LF”) RF signal selected between 125-134.2 kHz.

3. The method of claim 1 wherein the predetermined frequency is a low-frequency (“LF”) RF signal selected between 140-148.0 kHz.

4. The method of claim 1 wherein the predetermined frequency is a high-frequency (“HF”) RF signal of 13.56 MHz; and Ultra-High-Frequency (“UHF”) at 860-960 MHz.

5. The method of claim 1 wherein the predetermined frequency is an ultra-high-frequency (“UHF”) RF signal selected between 860-960 MHz.

6. The method of claim 1 wherein step 1 includes a further step of:
terminating the broadcasting of said signal after said second period of time.

7. The method of claim 1 wherein said method is a batch process.

8. The method of claim 1 wherein said method is a continuous process.

9. The method of claim 1 further including the step of:
testing a selected one of said first and second tags after exposure thereof for said second period of time to verify that said selected tag has self-tuned.

10. The method of claim 9 further including the step of:
depending on said testing, selectively adjusting at least one of said second predetermined strength and said second period of time.

11. Apparatus for simultaneously calibrating at least a first and a second radio frequency (“RF”) identification tag, each tag being adapted to self-tune when exposed for at least a first period of time to an RF signal of a predetermined frequency and at least a first predetermined strength, the apparatus comprising:
an RF transmitter adapted to produce an RF signal of said predetermined frequency and a second predetermined strength which is greater than said first predetermined strength;
an antenna coupled to the transmitter and adapted to broadcast said RF signal;
a structure adapted to support said first and second tags in proximity to said antenna so as to simultaneously expose said first and second tags to said broadcast signal such that the strength of said signal received by each of said tags is at least said first predetermined strength; and
a timer adapted to continue such exposure for a second period of time which is at least said first period of time.

12. The apparatus of claim 11 wherein the predetermined frequency is a low-frequency (“LF”) RF signal selected between 125-134.2 kHz.

13. The apparatus of claim 11 wherein the predetermined frequency is a low-frequency (“LF”) RF signal selected between 140-148.0 kHz.

14. The apparatus of claim 11 wherein the predetermined frequency is a high-frequency (“HF”) RF signal of 13.56 MHz; and Ultra-High-Frequency (“UHF”) at 860-960 MHz.

15. The apparatus of claim 11 wherein the predetermined frequency is an ultra-high-frequency (“UHF”) RF signal selected between 860-960 MHz.

16. The apparatus of claim 11 wherein said timer is further adapted to terminate the broadcasting of said signal after said second period of time.

17. The apparatus of claim 11 wherein said structure is adapted continuously to move said first and second tags with respect to said antenna during broadcast of said RF signal.

18. The apparatus of claim 11 wherein said structure is adapted periodically to move said first and second tags with respect to said antenna during broadcast of said RF signal.

19. The apparatus of claim 11 further comprising:
a tester adapted to test a selected one of said first and second tags after exposure thereof for said second period of time to verify that said selected tag has self-tuned.

20. The apparatus of claim 19 wherein, depending on said testing, said tester selectively adjusts at least one of said second predetermined strength and said second period of time.
